(19) United States
(12) Patent Application Publication
(10) Pub. No.: US 2012/0058372 A1
(43) Pub. Date: Mar. 8, 2012

(54) BATTERY PACK

(75) Inventor: Sang-Hun Park, Yongin-si (KR)

(73) Assignee: Samsung SDI Co., Ltd., Yongin-si (KR)

(21) Appl. No.: 13/114,474

(22) Filed: May 24, 2011

(30) Foreign Application Priority Data
Sep. 2, 2010 (KR) 10-2010-0086175

(51) Int. Cl. H01M 10/48

(52) U.S. Cl. 429/93

(57) ABSTRACT

A battery cell for identifying a state of battery cell. The battery pack includes: a battery cell; a switch contact unit electrically connected to the battery cell; a switch unit comprising a viscoelastic unit disposed to face the switch contact unit and contacting the switch contact unit so as to generate an on-signal for displaying a state of the battery cell; and a display unit for displaying the state of the battery cell.

### CROSS-REFERENCE TO RELATED APPLICATIONS

This application claims the benefit of Korean Patent Application No. 10-2010-0086175, filed on Sep. 2, 2010, in the Korean Intellectual Property Office, the disclosure of which is incorporated herein in its entirety by reference.

### BACKGROUND OF THE INVENTION

1. Field of the Invention

One or more embodiments of the present invention relate to a battery pack which may identify a state of battery cell.

2. Description of the Related Art

Electronic devices such as portable computers or machine tools receive a power source through a battery or an AC adaptor. Since portable computers or machine tools are used in a portable fashion, these devices may be used in a place where an external power source may not be available.

When an external power source is not available, devices are operated using a battery as a power source. Examination of the battery's capacity when starting operations is often needed prior to starting operations. For example, in portable computers, a charge state of battery may be examined by executing key input or icon selection while the computer is separately booting, in order to identify a residual quantity of battery life. However, this can be complicated and inconvenient.

Further, with switch based battery capacity indicators, misalignment of the switch used to identify the residual quantity of battery may result in an erroneous signal for identifying the residual quantity of battery and thus an accurate value may not be obtained. Also, when excessive force is exerted, the switch may be broken or separated.

### SUMMARY OF THE INVENTION

One or more embodiments of the present invention include a battery pack including a switch unit which may absorb increased exerted pressure and still accurately generate a signal for identifying a state of battery cell such as a residual quantity even in low assembly.

Additional aspects will be set forth in part in the description which follows and, in part, will be apparent from the description, or may be learned by practice of the presented embodiments.

According to one or more embodiments of the present invention, a battery pack includes: a battery cell; a switch contact unit electrically connected to the battery cell; a switch unit comprising a viscoelastic unit disposed to face the switch contact unit and contacting the switch contact unit so as to generate an on-signal for displaying a state of the battery cell; and a display unit for displaying the state of the battery cell.

The viscoelastic unit may surface-contact the switch contact unit.

The switch unit may include: a switch body on which a via hole is formed; and the viscoelastic unit protruded toward the one end of the switch body by passing the via hole.

The via hole may be formed to pass the center of the switch body.

The viscoelastic unit may be formed by hardening a viscoelastic material injected to the via hole.

The viscoelastic material may have viscosity of about 2500 to about 3500 mPa·s at about 25 to about 30° C.

The switch unit may further include a cap for covering the upper surface of the switch body.

The upper surface of the switch body may include injection holes connected to the via hole and the air, and an area thereof other than the injection holes that is blocked.

The viscoelastic unit may include a hardening resin.

The viscoelastic unit may include a material hardened by ultraviolet rays, infrared ray, or visible light.

The viscoelastic unit may include a material hardened in a heated or naturally remained state.

The viscoelastic unit may include a monomer, an oligomer, a photoinitiator, and an additive.

The state of the battery cell may be a residual quantity of the battery cell, and the display unit may include a plurality of light emitting diodes that are disposed to be spaced apart from each other and emit light.

The display unit may include a display panel.

The battery cell may further include a case that surrounds the edge of the battery cell and is opened to correspond to the switch unit.

### BRIEF DESCRIPTION OF THE DRAWINGS

These and/or other aspects will become apparent and more readily appreciated from the following description of the embodiments, taken in conjunction with the accompanying drawings of which:

FIG. 1 is an exploded perspective view schematically illustrating a battery pack, according to an embodiment of the present invention;

FIG. 2 is a side view illustrating an assembled state of the battery pack of FIG. 1 which shows a part where a switch unit and a switch contact unit are disposed;

FIG. 3 illustrates a display unit including a plurality of light emitting diodes (LEDs) which displays a residual quantity of battery cell according to an embodiment of the present invention;

FIG. 4 illustrates a display unit including a plurality of liquid crystal displays (LCDs) which displays a residual quantity of battery cell according to another embodiment of the present invention;

FIG. 5 is a perspective view illustrating a switch unit and a switch contact unit of FIG. 1;

FIG. 6 is a perspective view of the switch unit of FIG. 5 viewing from the bottom;

FIG. 7 is a side view of the switch unit and the switch contact unit of FIG. 5;

FIG. 8 is a side view illustrating arrangement and operation of a switch unit and a switch contact unit according to an embodiment of the present invention;

FIGS. 9 and 10 each illustrate a switch unit and a switch contact unit according to another embodiment of the present invention;

FIG. 11 is a detailed view illustrating a part of the battery pack according to another embodiment of the present invention; and

FIG. 12 is a perspective view schematically illustrating arrangement of a switch unit and a switch contact unit in the battery pack of FIG. 11.

### DETAILED DESCRIPTION OF THE PREFERRED EMBODIMENT

The exemplary embodiments of the present invention will be described in detail with reference to the accompanying drawings and description of the drawings so as to fully understand advantages and objectives of the present invention. The present invention may, however, be embodied in many different forms and should not be construed as being limited to the embodiments set forth herein; rather, these embodiments are provided so that this disclosure will be thorough and complete, and will fully convey the concept of the invention to those skilled in the art. The terminology used herein is for the purpose of describing particular embodiments only and is not intended to be limiting of exemplary embodiments. As used herein, the singular forms “a,” “an,” and “the,” are intended to include the plural forms as well, unless the context clearly indicates otherwise. It will be further understood that the terms “comprises” and/or “comprising” when used in this specification, specify the presence of stated elements, steps, operations, and/or components, but do not preclude the presence or addition of one or more other elements, steps, operations, and/or components. It will be understood that, although the terms first, second, third, etc., may be used herein to describe various elements, these elements should not be limited by these terms. These terms are only used to distinguish one element from another element.

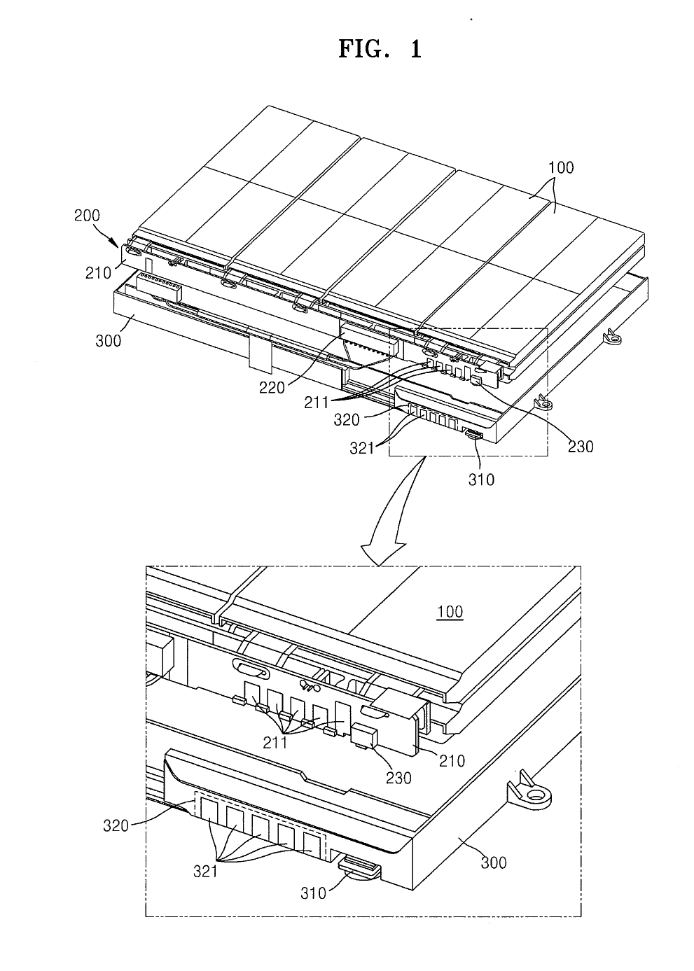

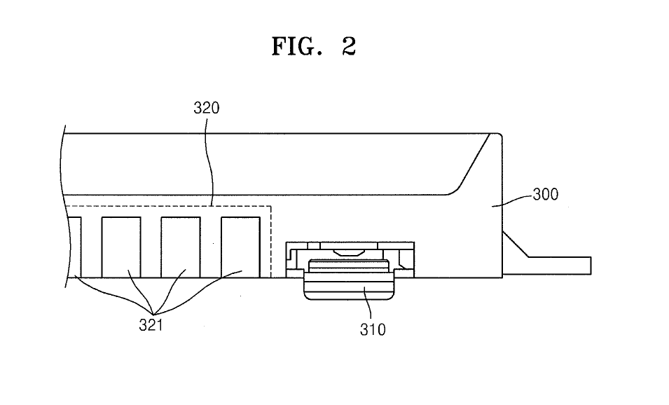

FIG. 1 is an exploded perspective view schematically illustrating a battery pack, according to an embodiment of the present invention and FIG. 2 is a side view illustrating an assembled state of the battery pack of FIG. 1 which shows a part where a switch unit 310 and a switch contact unit 230 are disposed.

Referring to FIG. 1, the battery pack includes a battery cell 100, a protection circuit module 200 for protecting the battery cell 100, a switch unit 310 for inputting an on signal that displays a residual quantity of the battery cell 100, a switch contact unit 230 for contacting the switch unit 310, and a case 300. In this structure, a state of the battery cell 100 such as charging time, a charge state, and a residual quantity of the battery cell 100 may be displayed. Hereinafter, for convenience of description, displaying of the residual quantity of the battery cell 100 is described.

The battery cell 100 supplies power to electronic devices such as laptop computers, machine tools, and the like. The battery cell 100 may be rechargeable and a plurality of the battery cells 100 may be included so as to supply sufficient power to electronic devices.

The protection circuit module 200 inhibits overheating and possible explosions generated due to excessive charge, excessive discharge, or excessive current in the battery cell 100. The protection circuit module 200 includes a substrate 210 disposed at one side of the battery cell 100 and a protection device 220 installed in the substrate 210. In the protection device 220, integrated circuits or safety elements including passive elements such as resistors or condensers or active elements such as field effect transistors may be selectively formed. Also, the protection device 220 may include a positive temperature coefficient (PTC) element.

The switch contact unit 230 is installed in the substrate 210 and is electrically connected to the battery cell 100 through the substrate 210 and various elements (not illustrated) installed in the substrate 210. The switch contact unit 230 generates an initial signal for detecting a residual quantity of the battery cell 100 through contact of the switch unit 310. According to the initial signal generated from the switch contact unit 230, data about the residual quantity of the battery cell 100 may be acquired. For example, the data about the residual quantity of the battery cell 100 may be acquired using a general method of acquiring a residual quantity of the battery cell.

In the current embodiment of the present invention, the switch contact unit 230 is installed in the substrate 210 of the protection circuit module 200; however, the present invention is not limited thereto. For example, the switch contact unit 230, and circuits or elements (not illustrated) that acquire data about the residual quantity of the battery cell 100 may be installed in a separate substrate (not illustrated).

A surface at one side of the switch contact unit 230, that is, a surface facing the switch unit 310, is projected so as to easily contact the switch unit 310. In the current embodiment of the present invention, a surface at one side of the switch contact unit 230 is projected; however, it may not be projected to still be within the scope of the present teachings.

The switch unit 310 is disposed to be spaced apart from the switch contact unit 230 so as to face the switch contact unit 230. When a user presses the switch unit 310 in order to identify the residual quantity of the battery cell 100, the switch unit 310 contacts the switch contact unit 230.

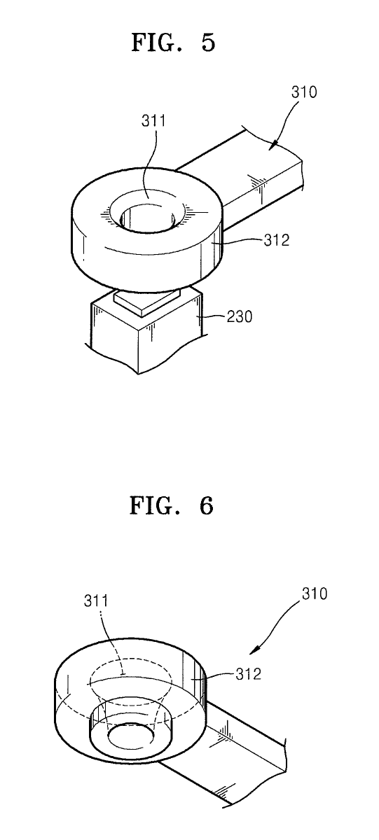

The switch unit 310 includes a material having viscoelasticity on the surface thereof facing the switch contact unit 230. The material having viscoelasticity improves contact between the switch unit 310 and the switch contact unit 230. Also, even if an excessive force is exerted to the switch unit 310, the material having viscoelasticity absorbs at least some of the exerted force and inhibits or even prevents the switch unit 310 or the switch contact unit 230 from being damaged and separated. The structure and operation of the switch unit 310 will be described more fully later with reference to FIGS. 5 through 7.

A display unit 320 displays a residual quantity of the battery cell 100. When the switch unit 310 inputs an on signal for displaying the residual quantity of the battery 100 through contact of the switch contact unit 230, the switch contact unit 230 generates an initial signal as described above and data about the residual quantity of the battery cell 100 may be acquired. The acquired data is output to a user through the display unit 320.

Referring to FIGS. 1 and 2, the display unit 320 includes a plurality of light emitting diodes (LEDs) 321. The plurality of LEDs 321 are disposed to be spaced apart from each other and are turned on and off according to the data about the residual quantity of the battery cell 100. The LEDs 321 may be disposed on LED connect units 211.

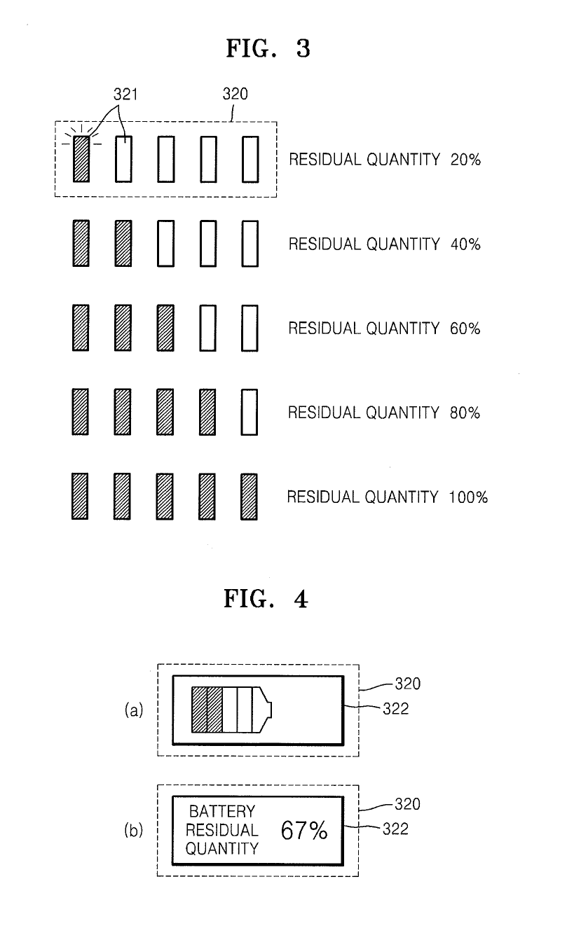

Referring to FIG. 3, according to the on and off state of the plurality of LEDs 321, the residual quantity of the battery cell 100 is displayed. When one LED 321 is turned on, it indicates that the residual quantity of about 0 to about 20% remains in the battery cell 100. In FIG. 3, five LEDs 321 are included; however, the number of LEDs may vary according to a state.

In the current embodiment, the display unit 320 includes the plurality of LEDs 321; however, the present invention is not limited thereto. For example, any light emitting device that emits light such as a small-sized electric lamp may be included.

FIG. 4 illustrates the display unit 320 including a plurality of liquid crystal displays (LCDs) 322. Referring to FIG. 4, the residual quantity of the battery may be output through the LCDs 322 with a bar type or a numerical value.

In the current embodiment of the present invention, the display unit 320 includes the plurality of LCDs 322; however, the present invention is not limited thereto. For example, any small-sized display panel which may display the residual quantity of the battery cell 100 such as OLEDs may be included.

The case 300 is disposed to surround the battery cell 100. The case 300 is partially opened so as to contain the switch unit 310. Also, the case 300 includes an area where the display unit 320 is disposed so as to expose the display unit 320 to the outside.

In the current embodiment, the residual quantity of the battery cell 100 is displayed; however, the present invention is not limited thereto. That is, in displaying of a state of the battery cell 100 such as charging time, or a charge state of the battery cell 100, it is obvious that the switch contact unit 230 generates an initial signal for acquiring corresponding state data and thereby the display unit 320 displays the corresponding state data as described with reference to FIGS. 1 through 4.

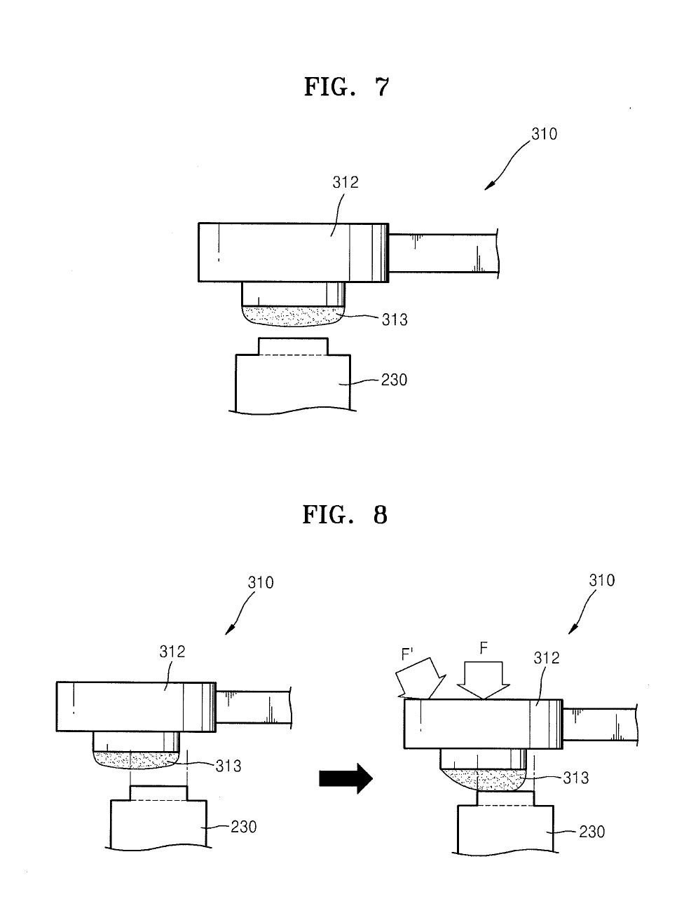

FIG. 5 is a perspective view illustrating the switch unit 310 and the switch contact unit 230, FIG. 6 is a perspective view of the switch unit 310 viewing from the bottom, and FIG. 7 is a side view of the switch unit 310 and the switch contact unit 230 of FIG. 5.

Referring to FIGS. 5 through 7, the upper surface of the switch unit 310 is exposed to the outside and the lower surface of the switch unit 310 is disposed to face the switch contact unit 230. The lower surface of the switch unit 310 is partially protruded and a via hole 311 is formed in the switch unit 310.

When a viscoelastic material is injected through the via hole 311, the viscoelastic material reduces or even minimizes the surface area at the end of the via hole 311 according to its own characteristic. Then a viscoelastic unit 313 is formed by hardening the viscoelastic material. In consideration of performance and workability of the viscoelastic material, the viscoelastic material may have viscosity of about 2500 to about 3500 mPa·s at about 25 to about 30° C. Referring to FIG. 7, the viscoelastic unit 313 is protruded toward the switch contact unit 230 because the viscoelastic material is hardened reducing the surface area of the viscoelastic material.

The viscoelastic material may be hardening resin. The viscoelastic material may be hardened by ultraviolet rays, infrared ray, or visible light in a heated or naturally remained state.

As an example, the viscoelastic material may be a mixture including a monomer, an oligomer, a photoinitiator, and an additive. For example, the mixture may be hardened when an integrated light quantity is 5000 mJ at wavelength of an UV-A region.

In the current embodiment, the viscoelastic material is injected to the via hole 311 and is hardened so that the switch unit 310 including the viscoelastic unit 313 is formed; however, the present invention is not limited thereto. For example, the switch unit 310 may be manufactured by injecting the viscoelastic material to a separate mold (not illustrated), hardening the viscoelastic material, thereby manufacturing the viscoelastic unit 313, and then fixing the manufactured viscoelastic unit 313 to the via hole 311 of a switch body 312.

FIG. 8 is a side view illustrating arrangement and operation of the switch unit 310 and the switch contact unit 230 according to an embodiment of the present invention.

In manufacturing of the battery pack, the arrangement of the switch unit 310 and the switch contact unit 230 may not be matched. That is, the switch unit 310 may not be matched with the contact unit 230 by an error generated while the switch unit 310 is contained in the case 300 or the switch contact unit 230 is installed in the substrate 210. In accordance with a compared embodiment, if the switch unit 310 doesn't include the viscoelastic unit 313, such an error can cause a contact defect of the switch unit 310 and thus an accurate signal may not be generated by the operation of the switch unit 310. However, according to an embodiment of the present invention, the viscoelastic unit 313 is disposed at one side of the switch unit 310 and thus the error may be compensated.

Referring to FIG. 8, when the switch unit 310 is not matched with the contact unit 230, the form of the viscoelastic unit 313 is slightly changed and contacts the switch contact unit 230. Accordingly, an initial signal for acquiring the data about the residual quantity of the battery cell 100 may be more accurately generated.

When the viscoelastic unit 313, in which the form thereof is changed, is removed from the switch contact unit 230, the viscoelastic unit 313 is changed again to its original form by elasticity, which is its own characteristic.

When a force F is excessively exerted to the switch unit 310, the viscoelastic unit 313 absorbs at least some of the force F according to its own characteristic. Accordingly, damage to the switch unit 310 and the switch contact unit 230 can be reduced or prevented.

Also, even if a force F′ for driving the switch unit 310 is exerted in a state that the force F′ is not exerted perpendicular to the upper surface of the switch unit 310 and is slant, the form of the viscoelastic unit 313 is changed and contacts the switch contact unit 230. Accordingly, an initial signal for acquiring the data about the residual quantity of the battery cell 100 may be accurately generated.

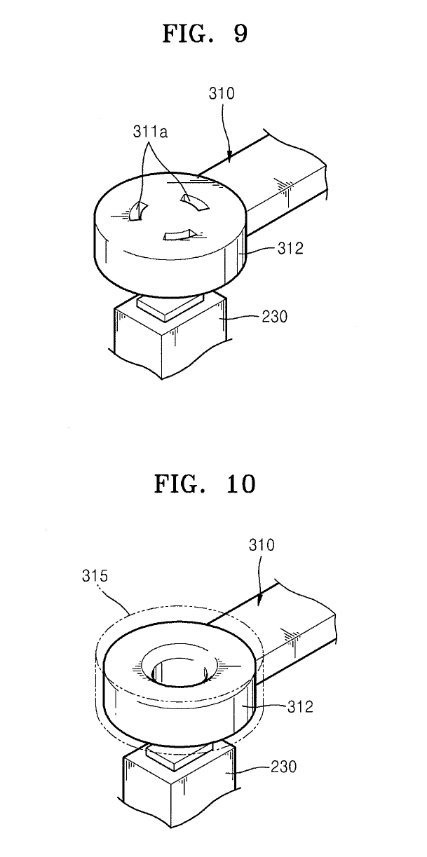

FIG. 9 illustrates the switch unit 310 according to another embodiment of the present invention.

In the current embodiment of the present invention, the switch unit 310 of FIG. 9 is the same as the switch unit 310 of FIG. 5 in that the via hole (not shown) is formed. However, the form of the upper surface of the switch body 312 is different.

Referring to FIG. 9, a plurality of injection holes 311a for injecting a viscoelastic material are formed on the upper surface of the switch body 312, and an area of the upper surface of the switch body 312 other than the injection holes 311a is blocked.

The injection holes 311a are connected to the air and the via hole. When the viscoelastic material is injected through the injection holes 311a, the injected viscoelastic material passes the via hole due to its flowability and is hardened at the end in a state that surface area is reduced or even minimized.

Since the area of the upper surface of the switch body 312 other than the injection holes 311a is blocked, the viscoelastic unit 313 may be prevented from being separated through the upper surface of the switch unit 310 after passing the via hole 311.

FIG. 10 illustrates the switch unit 310 according to another embodiment of the present invention.

Referring to FIG. 10, a cap 315 may be further formed on the upper surface of the switch unit 312. The cap 315 includes a soft material so that a user may experience the improved touch. When an excessive force is exerted to the switch unit 310, the cap 315 may absorb the force as in the viscoelastic unit 313, and the viscoelastic unit 313 may be inhibited from being separated through the upper surface of the switch unit 310 after passing the via hole 311.

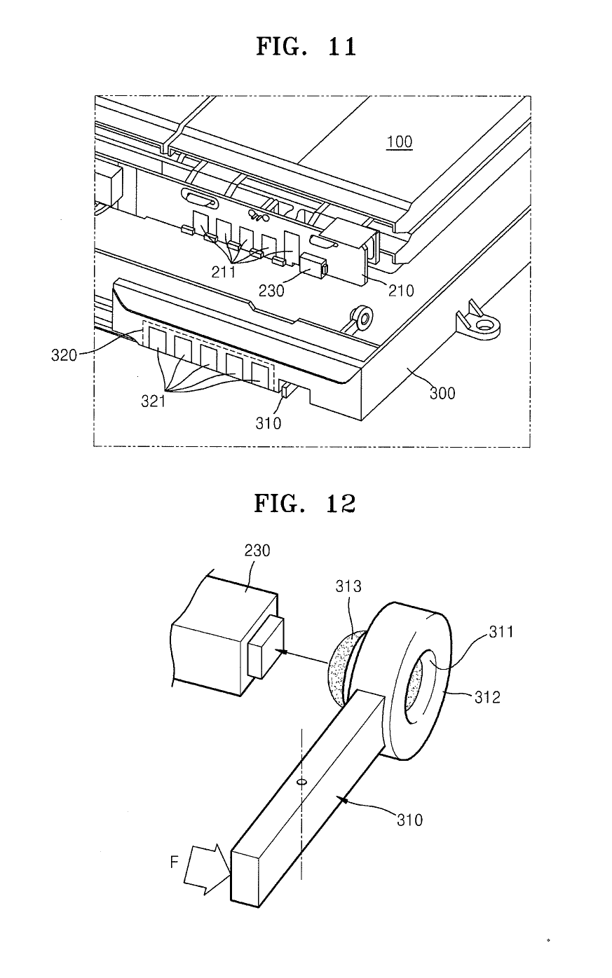

FIG. 11 is an exploded perspective view of a battery pack including the switch unit 310 according to another embodiment of the present invention and FIG. 12 is a perspective view schematically illustrating arrangement of the switch unit 310 and the switch contact unit 230 in the battery pack of FIG. 11.

The battery pack according to the current embodiment of the present invention is the same or substantially the same as the battery pack of FIG. 1 in that the protection circuit module 200 for protecting the battery cell 100, the switch unit 310 for inputting an on signal that displays a residual quantity of the battery cell 100, the switch contact unit 230 contacting the switch unit 310, and the case 300 are included.

However, in the current embodiment of the present invention, a direction and position of a force F exerted to the switch unit 310 are different. Hereinafter, for convenience of description, the difference will be mainly described.

Referring to FIGS. 11 and 12, one end of the switch unit 310 is exposed to the outside of the case 300. For example, when the force F is exerted to the left so that the one end of the switch unit 310 moves, the switch unit 310 is rotatably moved based on an axis. The viscoelastic unit 313 of the switch unit 310 that is rotatably moved based on an axis contacts the switch contact unit 230.

In the current embodiment of the present invention, an error generated due to the arrangement of the switch unit 310 and the switch contact unit 230 may be compensated by the characteristic of the viscoelastic unit 313. That is, even if the switch unit 310 is not matched with the switch contact unit 230, the form of the viscoelastic unit 313 is slightly different and thus the viscoelastic unit 313 may contact the switch contact unit 230. Accordingly, an initial signal for acquiring the data about the residual quantity of the battery cell 100 may be accurately generated.

When the viscoelastic unit 313, in which the form thereof is changed, is removed from the switch contact unit 230, the viscoelastic unit 313 is changed again to its original form by elasticity, which is its own characteristic.

As described above, according to the one or more of the above embodiments of the present invention, the viscoelastic unit is disposed on one side of the switch unit so that even if precision of assembly is low in such a way that the switch unit is not matched with the switch contact unit, performance of the switch unit may be ensured.

Also, even if an excessive force is exerted to the switch unit, the force may be absorbed so that the switch unit and the switch contact unit may be prevented from being damaged or separated from the battery pack.

It should be understood that the exemplary embodiments described therein should be considered in a descriptive sense only and not for purposes of limitation. Descriptions of features or aspects within each embodiment should typically be considered as available for other similar features or aspects in other embodiments.

What is claimed is:

1. A battery pack comprising:
a battery cell;
a switch contact unit electrically connected to the battery cell;
a switch unit comprising a viscoelastic unit disposed to face the switch contact unit and contacting the switch contact unit so as to generate an on-signal for displaying a state of the battery cell; and
a display unit for displaying the state of the battery cell.

2. The battery cell of claim 1, wherein the viscoelastic unit surface-contacts the switch contact unit.

3. The battery cell of claim 1, wherein the switch unit comprises:
a switch body on which a via hole is formed; and
the viscoelastic unit protruded toward the one end of the switch body by passing the via hole.

4. The battery cell of claim 3, wherein the via hole is formed to pass the center of the switch body.

5. The battery cell of claim 3, wherein the viscoelastic unit is formed by hardening a viscoelastic material injected to the via hole.

6. The battery cell of claim 5, wherein the viscoelastic material has viscosity of about 2500 to about 3500 mPa·s at about 25 to about 30° C.

7. The battery cell of claim 3, wherein the switch unit further comprises a cap for covering the upper surface of the switch body.

8. The battery cell of claim 3, wherein the upper surface of the switch body comprises injection holes connected to the via hole and the air, and an area thereof other than the injection holes is blocked.

9. The battery cell of claim 1, wherein the viscoelastic unit comprises a hardening resin.

10. The battery cell of claim 9, wherein the viscoelastic unit comprises a material hardened by ultraviolet rays, infrared ray, or visible light.

11. The battery cell of claim 9, wherein the viscoelastic unit comprises a material hardened in a heated or naturally remained state.

12. The battery cell of claim 1, wherein the viscoelastic unit comprises a monomer, an oligomer, a photoinitiator, and an additive.

13. The battery cell of claim 1, wherein the state of the battery cell is a residual quantity of the battery cell, and the display unit comprises a plurality of light emitting diodes that are disposed to be spaced apart from each other and emit light.

14. The battery cell of claim 1, wherein the display unit comprises a display panel.

15. The battery cell of claim 1, further comprising a case that surrounds the edge of the battery cell and is opened to correspond to the switch unit.

16. An electrical assembly having a battery comprising:
at least one battery cell;
a display that displays information indicative of the state of charge of the at least one battery cell;
a switch contact unit that is engaged to the at least one battery cell so as to be able to result in information indicative of the state of charge of the at least one battery cell being provided to the display;
a switch unit that is operable by a user so that the switch unit engages with the switch contact unit, the switch contact unit induces the delivery of information indicative of the state of charge of the at least one battery cell to the display;
a viscoelastic member that is interposed between the switch contact unit and the switch unit wherein the viscoelastic member is formed of a material that absorbs at least some of the force exerted on the switch unit and the switch contact unit when the switch unit is operated by the user.

17. The electrical assembly of claim 16, wherein the viscoelastic member is formed on the switch unit.

18. The electrical assembly of claim 16, wherein the viscoelastic member is formed such that misalignment of the switch unit and the switch contact unit results in elastic deformation of the viscoelastic member so as to enhance physical contact between the switch unit and the switch contact unit.

19. The electrical assembly of claim 16, wherein the switch unit comprises:
a switch body on which a via hole is formed; and
the viscoelastic unit protruded toward the one end of the switch body by passing the via hole.

20. The electrical assembly of claim 19, wherein the upper surface of the switch body comprises injection holes connected to the via hole and the air, and an area thereof other than the injection holes is blocked.
